(19) United States
(12) Patent Application Publication
(10) Pub. No.: US 2010/0164424 A1
(43) Pub. Date: Jul. 1, 2010

(54) TOOL COMPENSATION SYSTEM AND METHOD FOR COMPUTER NUMERICAL CONTROL MACHINE

(75) Inventor: CHING-CHENG YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/354,784

(22) Filed: Jan. 16, 2009

(30) Foreign Application Priority Data
Dec. 27, 2008 (CN) 200810306601.X

(51) Int. Cl. G05B 19/25

(52) U.S. Cl. 318/572

(57) ABSTRACT

A tool compensation system for compensating abrasion of a tool includes a rangefinder, a control system, and a compensation apparatus. The compensation apparatus includes an actuator, a transmission element, and a regulator. The rangefinder measures an actual length of the tool. The control system calculates a compensation value according to the actual length, and outputs a control instruction to the compensation apparatus according to the compensation value. The transmission element is actuated by the actuator to move a distance equaling to the compensation value in response to receiving the control instruction. The regulator is configured for supporting an article to be machined by the tool, and capable of moving towards the tool under the actuation of the transmission element, to compensate for abrasion of the tool.

### BACKGROUND

1. Technical Field

The present disclosure relates to compensation systems and methods, and particularly to a tool compensation system and a tool compensation method for a computer numerical control (CNC) machine.

2. Description of the Related Art

A tool is a significant component of a CNC machine used for machining metal articles. Generally, tool wear may occur during the machining processes, which may result in size variations of the articles. Therefore, a single-spindle CNC machine employs a tool compensation system for compensating abrasion of a single tool mounted on the single-spindle.

A multi-spindle CNC machine greatly enhances production capacity. However, abrasion of the many tools mounted on the multi-spindle CNC machine may not be consistent. Thus, the tool compensation system may affect machining precision of the multi-spindle CNC machine.

### BRIEF DESCRIPTION OF THE DRAWINGS

FIG. 1 is a block diagram of an embodiment of a tool compensation system for a CNC machine.

FIG. 2 is a flowchart of an embodiment of a tool compensation method for a CNC machine.

### DETAILED DESCRIPTION

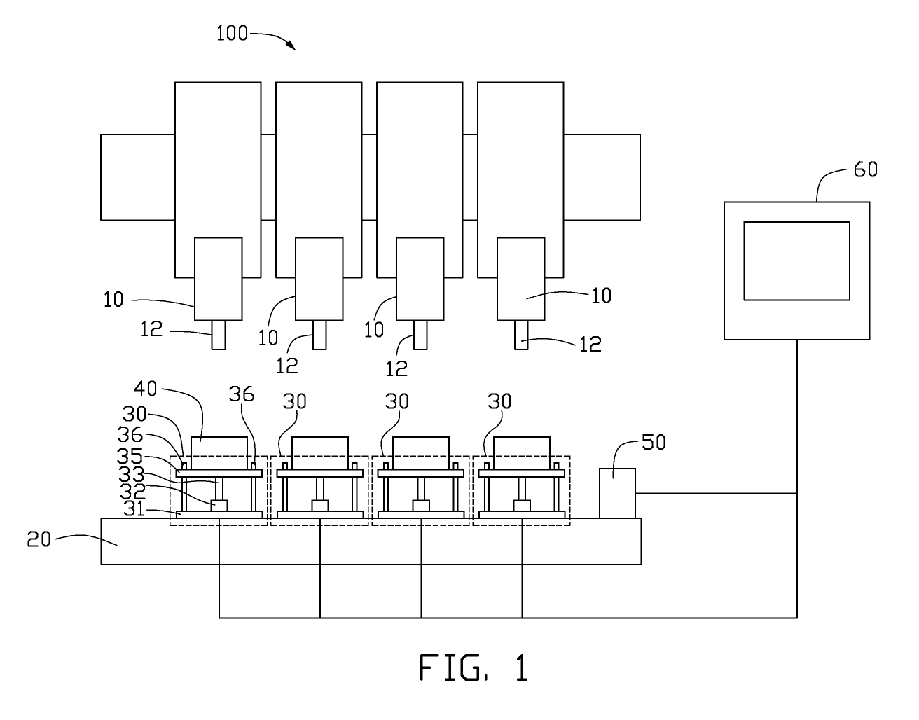

Referring to FIG. 1, an exemplary embodiment of a tool compensation system 100 includes four tools 12, a working platform 20, four compensation apparatuses 30 mounted on the working platform 20 configured for compensating for abrasion of the four tools 12 respectively, a rangefinder 50 configured for measuring actual lengths of the four tools 12, and a control system 60 connected to the four compensation apparatuses 30 and the rangefinder 50. The control system 60 is configured for controlling the four compensation apparatuses 30 to compensate for abrasion of the four tools 12 respectively. In one example, the control system 60 controls the four compensation apparatuses 30 to compensate for the abrasion of the four tools 12, according to the actual lengths of the four tools 12 received from the rangefinder 50, before starting up a machining circle for example. It may be understood that a machining circle is a machining segment with a pre-determined tool cutting length.

Generally, the tool compensation system 100 is applied in a computer numerical control (CNC) machine, such as a multi-spindle CNC machine. The four tools 12 may be fixed to four spindles 10 of the multi-spindle CNC machine for machining four articles 40 on the four compensation apparatuses 30 respectively. In one embodiment, the four tools 12 can be four milling cutters, the four articles 40 can be objects made of metal, and the rangefinder 50 can be a laser rangefinder. In other embodiments, the number of the spindles 10, the tools 12, and the compensation apparatuses 30 can be varied according to actual need.

In one embodiment, each of the compensation apparatuses 30 includes a support 31 fixed on the working platform 20, an actuator 32 mounted on the support 31 and connected to the control system 60, a transmission element 33 connected to the actuator 32, a regulator 35 mounted to the transmission element 33, and two guiding poles 36 connected to the support 31 and running through the regulator 35. The regulator 35 can move along the two guiding poles 36, under actuation of the actuator 32 and the transmission element 33. In one embodiment, the actuator 32 can be a servomotor.

In use, the rangefinder 50 measures an actual length L1 of a tool 12, and transmits the actual length L1 to the control system 60, before the article 40 under the tool 12 is machined. The control system 60 compares the actual length L1 with a previous length L2 of the tool 12 measured by the rangefinder 50 before the last machining circle run and stored in the control system 60, to obtain a compensation value L=L2−L1. The control system 60 replaces the previous length L2 with the actual length L1 to update the length of the tool 12 stored in the control system 60. An actuator 32 of the compensation apparatus 30 actuates a transmission element 33 to move a distance equal to the compensation value L, after receiving a control instruction from the control system 60. The transmission element 33 actuates a regulator 35 to move towards the tool 12 to compensate for abrasion of the tool 12.

For example, when the actual length L1 measured by the rangefinder 50 is about 4.999 cm, and the previous length L2 stored in the control system 60 is about 5.000 cm, then the compensation value L calculated by the control system 60 is about 0.001 cm, that is L=L2−L1=5.000 cm−4.999 cm=0.001 cm. The control system 60 controls the actuator 32 to work according to the compensation value L. The actuator 32 actuates the transmission element 33 to move a distance equal to 0.001 cm, and the transmission element 33 drives the regulator 35 to move towards the tool 12 to compensate for abrasion of the tool 12. The article 40 therefore can be put on the regulator 35 to be machined by the tool 12.

Likewise, abrasion of the other tools 12 can be compensated by the corresponding compensation apparatuses 30 under the control of the control system 60 using the same process as mentioned above. Even though abrasion of the tools 12 may be different for different tools, each tool is easily and uniquely compensated by the corresponding compensation apparatuses 30 before every machining circle run, and the multi-spindle CNC machine can machine the articles 40 with a high machining precision.

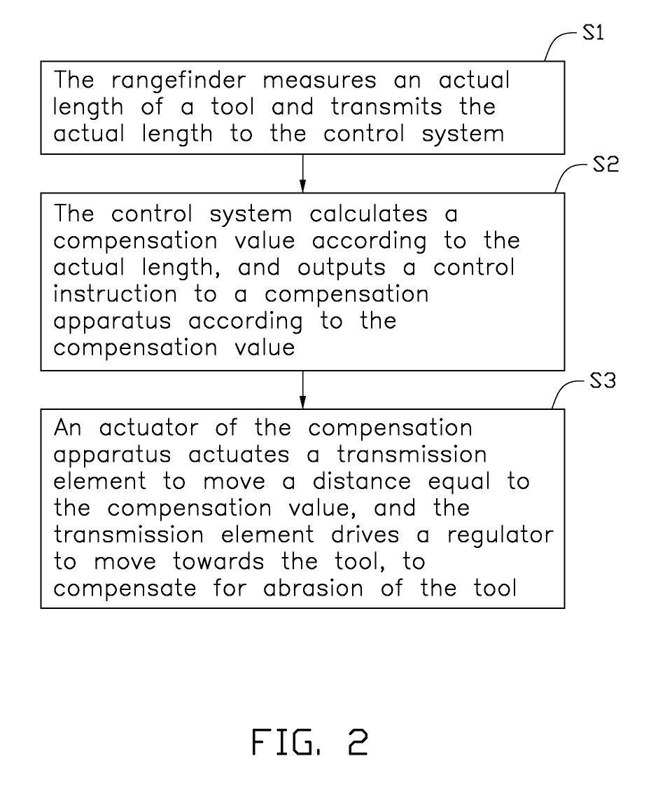

Referring to FIG. 2, a tool compensation method includes the following blocks. Depending on the embodiment, certain blocks described below may be removed, others may be added, and the sequence of the blocks may be altered.

In block S1, the rangefinder 50 measures an actual length L1 of a tool 12 and transmits the actual length L1 to the control system 60.

In block S2, the control system 60 compares the actual length L1 with a previous length L2 of the tool 12 measured by the rangefinder 50 before the last machining circle run and stored in the control system 60, to obtain a compensation value L=L2−L1. Then, the control system 60 replaces the previous length L2 with the actual length L1 to update the length of the tool 12 stored in the control system 60, and outputs a control instruction to a compensation apparatus 30 according to the compensation value L.

In block S3, an actuator 32 of the compensation apparatus 30 actuates a transmission element 33 to move a distance equal to the compensation value L, after receiving the control instruction from the control system 60. A transmission element 33 of the compensation apparatus 30 actuates a regulator 35 to move towards the tool 12 to compensate for abrasion of the tool 12.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A tool compensation system for compensating for abrasion of a tool, the system comprising:
a rangefinder configured for measuring an actual length of the tool;
a control system configured for storing a previous length of the tool, and capable of calculating a compensation value according to the actual length received from the rangefinder, and outputting a control instruction according to the compensation value; and
a compensation apparatus comprising:
an actuator configured for receiving the control instruction from the control system;
a transmission element capable of being actuated by the actuator to move a distance equal to the compensation value in response to receiving the control instruction; and
a regulator configured for supporting an article to be machined by the tool, wherein the regulator is capable of moving towards the tool under the actuation of the transmission element, and is configured to compensate for abrasion of the tool.

2. The system of claim 1, wherein the previous length of the tool is measured by the rangefinder before the last machining circle, and is stored in the control system.

3. The system of claim 2, wherein the control system subtracts the previous length from the actual length to obtain the compensation value.

4. The system of claim 3, wherein the control system replaces the previous length with the actual length to update the length of the tool stored in the control system timely, after obtaining the compensation value.

5. The system of claim 4, wherein the compensation apparatus further comprises:
a support configured for supporting the actuator, wherein the actuator is connected to the control system and the transmission element; and
two guiding poles connected to the support and running through the regulator, wherein the regulator connected to the transmission element can move along the two guiding poles under actuation of the transmission element.

6. A tool compensation method for compensating for abrasion of a tool, the method comprising:
measuring an actual length of the tool by a rangefinder;
calculating a compensation value according to the actual length by a control system, wherein the control system stores a previous length of the tool;
outputting a control instruction according to the compensation value by the control system;
actuating a transmission element to move a distance equal to the compensation value by an actuator element in response to receiving the control instruction from the control system; and
actuating a regulator that supports an article to be machined to move towards the tool by the transmission element, to compensate for abrasion of the tool.

7. The method of claim 6, wherein the previous length of the tool is measured by the rangefinder before the last machining circle, and is stored in the control system.

8. The method of claim 7, wherein the control system subtracts the previous length from the actual length to obtain the compensation value.

9. The method of claim 8, wherein the control system replaces the previous length with the actual length to update the length of the tool stored in the control system timely, after obtaining the compensation value.
